(19) United States
(12) Patent Application Publication
(10) Pub. No.: US 2007/0091751 A1
(43) Pub. Date: Apr. 26, 2007

(54) Optical disk apparatus and optical disk control method performing optimum power calibration

(75) Inventor: Takayuki Ono, Osaka (JP)

Correspondence Address: OSHA LIANG L.L.P., 1221 MCKINNEY STREET, SUITE 2800, HOUSTON, TX, 77010, US

(73) Assignee: Funai Electric Co., Ltd., Daito-shi (JP)

(21) Appl. No.: 11/546,641

(22) Filed: Oct. 12, 2006

(30) Foreign Application Priority Data
Oct. 20, 2005 (JP) 2005-306062

(51) Int. Cl. G11B 7/12

(52) U.S. Cl. 369/47.53

(57) ABSTRACT

In OPC where test writing is performed in a power calibration area of an optical disk by changing laser power in a plurality of levels to obtain optimum laser power based on the result, the optical disk apparatus prepares two change patterns of the laser power and uses them alternately. Thus, compared to the conventional case where a fixed sector would suffer a large damage by test writing, the number of times the OPC can be conducted increases, and accordingly, the possible number of times of data rewriting increases.

### BACKGROUND OF THE INVENTION

1.Field of the Invention

The present invention relates to an optical disk apparatus and an optical disk control method, and particularly to an optical disk apparatus and an optical disk control method that perform test writing in a power calibration area of an optical disk by changing laser power in a plurality of levels to obtain optimum laser power for use in writing data on the optical disk based on the result.

2. Description of the Background Art

When writing data on a recordable or rewritable optical disk (DVD±IRW, DVD-RAM or the like), optimum laser power varies depending on media characteristics of the optical disk, laser characteristics of the recording drive, and the like. Thus, in an optical disk apparatus, test writing is performed in a power calibration area (PCA) located on the innermost periphery of the optical disk, with the laser power changed stepwise in a plurality of levels, and the optimum laser power obtained from the result is used for actual writing of data in a data area of the optical disk. Such a technique of obtaining optimum laser power using a power calibration area is called Optimum Power Calibration (OPC) (see, e.g., Japanese Patent Laying-Open No. 2002-288833).

A conventional optical disk apparatus, however, is provided with only one pattern of change of laser power. When the OPC is conducted repeatedly, a portion in the power calibration area written with high power will suffer a large damage, posing a problem that no more OPC, and hence, no more data rewriting is possible.

### SUMMARY OF THE INVENTION

In view of the foregoing, a primary object of the present invention is to provide an optical disk apparatus and an optical disk control method that can increase the possible number of times of data rewriting on an optical disk.

An optical disk apparatus according to the present invention irradiates an optical disk with laser light to perform writing and reading of data. The apparatus includes: a writing unit performing test writing of a signal in a power calibration area of the optical disk by changing laser power in a plurality of levels; a reading unit reading the signal test-written in the power calibration area by the writing unit; and an operation unit obtaining optimum laser power for use in writing data in a data area of the optical disk based on the signal read by the reading unit, wherein the writing unit changes a change pattern of the laser power every time the test writing of the signal is performed.

An optical disk control method according to the present invention is for performing test writing in a power calibration area of an optical disk by changing laser power in a plurality of levels to obtain optimum laser power for use in writing data on the optical disk based on a result of the test writing, wherein a change pattern of the laser power is changed every time the test writing is performed.

Preferably, a plurality of sequenced change patterns are stored, and when the test writing is performed, the laser power is changed based on the change pattern next in order to the change pattern used in the previous test writing.

Still preferably, a plurality of change patterns are stored, and when the test writing is performed, one of the plurality of change patterns is selected at random, and the laser power is changed based on the selected change pattern.

According to the optical disk apparatus and the optical disk control method of the present invention, the pattern of change of the laser power is changed every time test writing is conducted. This means that the position written with high power changes for each test writing. Accordingly, compared to the conventional case where the position written with high power is fixed, the possible number of times of conducting the OPC, and hence, the possible number of times of rewriting of data, increases.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a main part of an optical disk apparatus according to an embodiment of the present invention.

FIG. 2 shows an optical disk on which writing/reading of data is performed by the optical disk apparatus shown in FIG. 1.

FIGS. 3A and 3B illustrate an OPC operation of the optical disk apparatus shown in FIG. 1.

### DESCRIPTION OF THE PREFERRED EMBODIMENTS

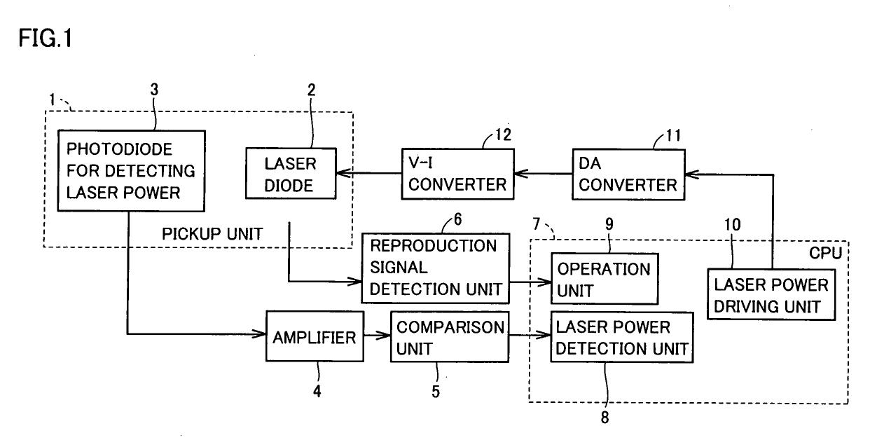

Referring to FIG. 1, an optical disk apparatus according to an embodiment of the present invention includes a pickup unit 1, an amplifier 4, a comparison unit 5, a reproduction signal detection unit 6, a CPU (central processing unit) 7, a DA converter 11, and a V-I converter 12.

Pickup unit 1 includes a laser diode 2 that irradiates an optical disk with writing and reading laser light, and a photodiode 3 that receives part of the laser light emitted from laser diode 2 and performs photoelectric conversion to output an analog electric signal at a level corresponding to the received amount of light. Pickup unit 1 also receives the laser light emitted from laser diode 2 and reflected from the optical disk, and performs photoelectric conversion to output a reproduction signal.

Amplifier 4 amplifies the analog electric signal output from photodiode 3 and provides the resultant signal to comparison unit 5. Comparison unit 5 compares the value of the output signal of amplifier 4 with a reference value, and outputs a differential signal thereof Reproduction signal detection unit 6 detects the reproduction signal output from pickup unit 1, and converts the detected reproduction signal to a digital signal.

CPU 7 includes a laser power detection unit 8, an operation unit 9 and a laser power driving unit 10, and performs various operations and processing. Laser power detection unit 8 detects laser power based on the differential signal output from comparison unit 5. Operation unit 9 reproduces recorded data on the optical disk based on the detected result of reproduction signal detection unit 6. Operation unit 9 also provides a command value to laser power driving unit 10, based on the detected result of laser power detection unit 8, such that laser power attains a target value. Operation unit 9 also performs OPC, as will be described later.

Laser power driving unit 10 outputs a laser drive signal based on the command value received from operation unit 9. DA converter 11 converts the laser drive signal to an analog signal. V-I converter 12 converts the voltage of the output signal of DA converter 11 to a current, and supplies the current to laser diode 2. Laser diode 2 emits laser light of laser power of the value corresponding to the output current of DA converter 11.

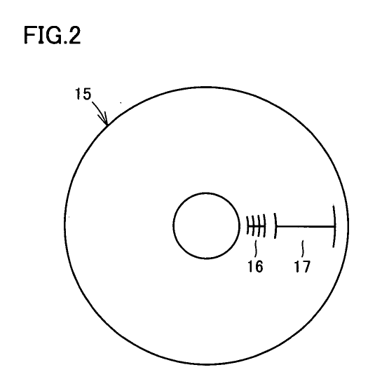

The OPC operation of the optical disk apparatus will now be described. As shown in FIG. 2, a power calibration area 16 is provided on the inner peripheral side of optical disk 15, and a data area 17 is provided on the outer peripheral side thereof Power calibration area 16 is divided into a test area and a count area, which are each separated into a plurality of (for example, 100) partitions. One partition in the test area is formed of 15 sectors, and the 15 sectors of one partition are used for test writing of one time. The number of times of test writing performed is recorded in the count area. In the OPC, test writing is carried out on the 15 sectors with 15 intensity levels of laser power, for example, and the laser power resulting in the best recording state is selected. This optimum laser power is used when writing data in data area 17 of the relevant optical disk 15.

The recording state of a signal is represented by a recording state index value. The recording state index value may be obtained by, e.g., a Beta method, a Gamma method, a Modulation method, and the like. For example, in the Beta method, when a peak value and a bottom value of the reproduction signal (RF signal) are represented as A1 and A2, respectively, the recording state index value β is obtained as follows: β=(A1+A2)/(A1−A2). The laser power with which this β value becomes the target value is determined to be the optimum laser power. Change of the laser power in a plurality of levels, calculation of the recording state index value, and selection of the optimum laser power are carried out by operation unit 9.

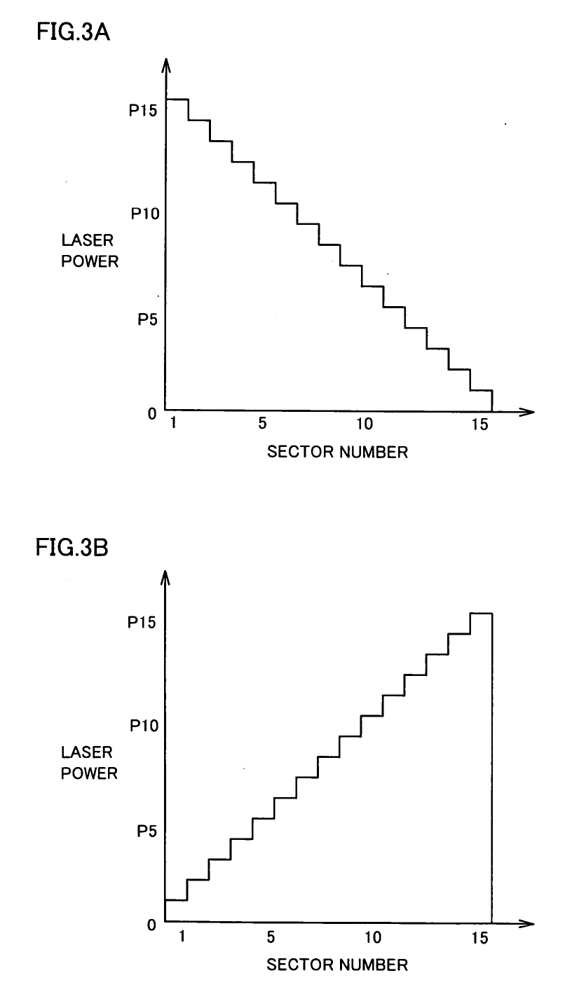

FIGS. 3A and 3B show laser power change patterns in the OPC. In the change pattern of FIG. 3A, signals of laser power P15-P1 are written into sectors 1-15, respectively. The signals are written into the sectors of smaller numbers with the greater laser power, with P15 being maximum and P1 being minimum.

Conventionally, the laser power change pattern was fixed to a single pattern as shown in FIG. 3A, for example. Thus, at every test writing, the signal was written into sector 1 with maximum laser power P15, causing a large damage to sector 1, thereby hindering any more OPC.

In view of the foregoing, according to the present invention, an additional change pattern as shown in FIG. 3B is prepared as well, and the change pattern of FIG. 3A and the change pattern of FIG. 3B are used alternately for each test writing. In the change pattern of FIG. 3B, signals of laser power P1-P15 are written into sectors 1-15, respectively, i.e., the signals being written into the sectors of larger numbers with the greater laser power. Operation unit 9 stores two change patterns, and reads them alternately for use.

For example, when the change pattern of FIG. 3A and the change pattern of FIG. 3B are used alternately for performing test writing on 15 sectors of one partition, the damages to the 15 sectors are averaged, and the number of times that test writing can be conducted on sector 1 becomes approximately twice that of the conventional case. As such, according to the present invention, the possible number of times of test writing, and hence, the possible number of times of data rewriting increases.

While two change patterns are used alternately in the present embodiment, more than two sequenced change patterns may be stored, and upon test writing, the change pattern next in order to the one used in the previous test writing may be selected so as to change the laser power according to the relevant change pattern. Alternatively, a plurality of change patterns may be stored, and any one of the change patterns may be selected at random for each test writing, to change the laser power according to the relevant change pattern.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An optical disk apparatus irradiating an optical disk with laser light to perform writing and reading of data, comprising:
a writing unit performing test writing of a signal in a power calibration area of said optical disk by changing laser power in a plurality of levels;
a reading unit reading the signal test-written into said power calibration area by said writing unit; and
an operation unit obtaining optimum laser power for use in writing data in a data area of said optical disk, based on the signal read by said reading unit; wherein
said writing unit changes a change pattern of said laser power every time said test writing of the signal is performed.

2. An optical disk control method of performing test writing in a power calibration area of an optical disk by changing laser power in a plurality of levels and obtaining optimum laser power for use in writing data on said optical disk based on a result of the test writing, wherein
a change pattern of said laser power is changed every time said test writing is performed.

3. The optical disk control method according to claim 2, wherein
a plurality of sequenced change patterns are stored, and
when said test writing is performed, said laser power is changed based on the change pattern next in order to the change pattern used in the previous test writing.

4. The optical disk control method according to claim 2, wherein
a plurality of change patterns are stored, and
when said test writing is performed, one of said plurality of change patterns is selected at random, and said laser power is changed based on the selected change pattern.
